(19) United States
(12) Patent Application Publication
(10) Pub. No.: US 2004/0111400 A1
(43) Pub. Date: Jun. 10, 2004

(54) Method for automatic wrapper generation

(75) Inventor: Pierre-Yves Chevalier, Biviers (FR)

Correspondence Address: Patent Documentation Center, Xerox Corporation, Xerox Square 20th Floor, 100 Clinton Ave. S., Rochester, NY, 14644, US

(73) Assignee: Xerox Corporation

(21) Appl. No.: 10/316,229

(22) Filed: Dec. 10, 2002

(51) Int. Cl. G06F 17/30

(52) U.S. Cl. 707/3; 715/513

(57) ABSTRACT

A method of automatically generating a wrapper for extracting variable data from a Web-site includes providing a result page from the Web-site; detecting repeating sequences of HTML tags in the page, wherein a sequence includes at least two HTML tags enclosing at least one text field for containing variable data; determining the longest and most frequently repeated sequence; generating an expression for extracting variable data using the first determined sequence; and assigning a label to the at least one text field within the first determined sequence. The method is automatic in that no annotated, sample pages are required for the method to work. Labels can be generated by a hypothesizing algorithm or by evaluating the HTML tags for possible information or by some other technique.

### CROSS-REFERENCE TO RELATED APPLICATIONS

This invention is related to co-assigned, co-pending U.S. application Ser. No. 09/361,496 filed Jul. 26, 1999, for “System and Method for Automatic Wrapper Grammar Generation”, which is incorporated herein by reference. This application is related to provisional Application No. 60/397,152 filed Jul. 18, 2002, which is incorporated herein by reference.

### FIELD OF THE INVENTION

This invention relates generally to wrappers, and more particularly to a method for automatic generation of wrappers.

### BACKGROUND OF THE INVENTION

A wrapper is a type of software component or interface that is tied to data which encapsulates and hides the intricacies of an information source in accordance with a set of rules. Wrappers are associated with the particular information source and its associated data type. For example, HTTP wrappers interact with HTTP servers and HTML documents; JDBC wrappers work with ODBC-compliant databases; and DMA wrappers work with DMA-compliant document management systems.

The World Wide Web (Web) represents a rich source of information in various domains of human activities and integrating Web data into various user applications has become a common practice. These applications use wrappers to encapsulate access to Web information sources and to allow the applications to query the sources like a database. Wrappers fetch HTML pages, static or ones generated dynamically upon user requests, extract relevant information and deliver it to the application, often in XML format. Web wrappers include a set of extraction rules that instruct an HTML parser how to extract and label content of a web page. A wrapper created for a particular web site usually extracts results in the form of attribute/value pairs from a raw HTML page.

askOnce is a universal search tool that conducts searches across heterogeneous repositories, multiple web-sites in multiple languages and generates a coherent synthesis of the most relevant information. askOnce, like many other search tools, relies on wrappers to communicate with external information sources. Wrappers provide a thin layer of software that transforms a uniform interface on top of heterogeneous networked information sources and enable services like askOnce. One of the values of askOnce comes from its ability to be quickly connected to any source in any format and to be rapidly integrated into all to environments. However this requires developing a wrapper which adapts askOnce to the peculiar communication protocol of each source.

To keep up with the expanding number of repositories and web-sites, a service such as askOnce must be able to generate wrappers for new repositories and web-sites quickly.

Various techniques for generating wrappers exist, including for example, the wrapper induction techniques. Wrapper induction methods involve generalizing from a set of example pages which have been manually annotated with the text fragments to be extracted. askOnce generally provides two ways to generate wrappers: programmatically or a learning-based tool. The learning-based tool is a graphical tool which builds a wrapper through a learn by example approach (a wrapper induction technique). (See U.S. application Ser. No. 09/361,496 filed Jul. 26, 1999, for “System and Method for Automatic Wrapper Grammar Generation” to Boris Chidlovskii). The learning-based tool is semi-automatic and requires the wrapper designer to manually train the system. The programmatic method involves writing a rule-based grammar which is similar to writing a piece of software code and requires an expert programmer.

The cost of integrating a new web-site within a service such as askOnce using one of the existing techniques is somewhat expensive. The cost of wrapping a new web service within a Web service framework using the existing techniques is also somewhat expensive. What is needed is an automatic, inexpensive method of integrating new web-sites and wrapping new web services. It would be desirable to have a method of wrapper generation which does not require manual annotation of examples. It would also be desirable to have method of wrapper generation which could be integrated into a service and which could generate a wrapper automatically and cost effectively for each newly found Web-site.

### SUMMARY OF THE INVENTION

A method of automatically generating a wrapper for extracting variable data from a Web-site, according to the invention, includes providing a result page from the Web-site; detecting repeating sequences of HTML tags in the page, wherein a sequence comprises at least two HTML tags enclosing at least one text field for containing variable data; determining the longest and most frequently repeated sequence; generating an expression for extracting variable data using the first determined sequence; and assigning a label to the at least one text field within the first determined sequence. If there are a large number of other repeating tag sequences, additional sequences may be determined and added to the wrapper. The second longest and second most frequently repeated sequence can be determined (and its corresponding text fields assigned labels), then the third and so on until all desired repeating tag sequences have been identified.

The method of the invention is automatic in that no annotated, sample pages are required for the method to work. The method works with a single page of results from a Web-site. The method of automatic wrapper generation provides very quick integration of a Web site within a service such as askOnce. The method detects repeating patterns of HTML tags, selecting the longest and the most frequent sequence, then labels the variable data within such sequences. Labels can be generated by a hypothesizing algorithm or by evaluating the HTML tags for possible information or by some other technique.

Wrappers will continue to play a role for the deployment of enterprise-wide services. While new standards such as SOAP or UDDI are emerging, the integration of legacy systems or even external World-Wide Web systems into a coherent service will still, and to a large extent, rely on wrappers. The method of automatic wrapper generation of the invention is a key component to help realize this vision. The method allows for a very quick integration of a Web site within a service such as askOnce. The method detects repeating patterns of HTML tags and selects the longest and the most frequent sequence. Experiments have demonstrated that the method works well with fairly regular lists of results. The method can even accommodate minor variations in the tag sequence. The method of automatic wrapper generation is complementary to the existing wrapper generation techniques, including the wrapper induction techniques.

### BRIEF DESCRIPTION OF THE FIGURES

FIG. 1 is a flow chart of a method of automatically generating a wrapper;

FIG. 2 is a table of HTML tags and their definitions; and

FIG. 3 is a block diagram of an overall system including a method of automatically generating a wrapper.

### DETAILED DESCRIPTION OF THE EMBODIMENTS

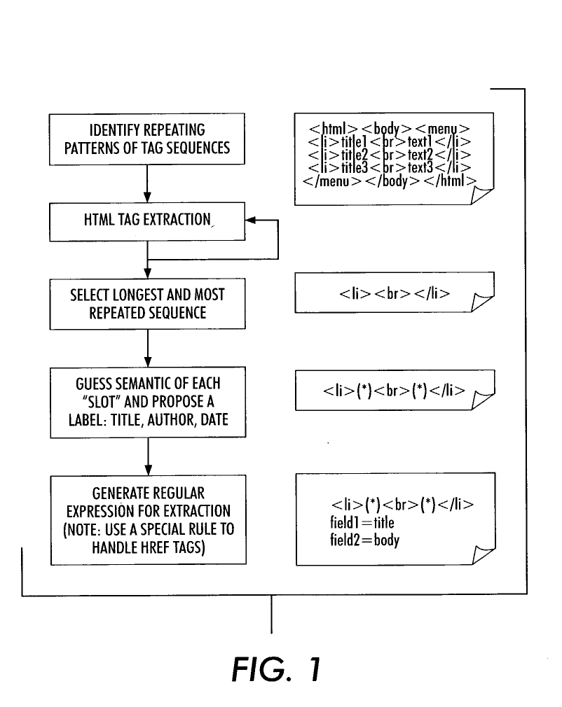

FIG. 1 illustrates the method to generate a wrapper. Referring to FIG. 1, a method of automatic wrapper generation is shown therein. A page 20 of results from a Web-site is provided. Only a single page of results is required (a single page may be much larger than a typical letter size piece of paper; a single page of results is the page of results that would be displayed by the Web-site). The page of results is not manually annotated; nor must sample pages be provided as in a wrapper induction method. In step 10, HTML tags are extracted from page 20. In step 12 repeating patterns of tag sequences are identified. Note from page 20, there are sequences <html><body><menu>, <li><br></and </menu></body><html>. In step 14 the longest and most repeated sequence of tags is determined. In this example, the longest and most repeated sequence is sequence 22: <li><br></li>. In step 16 a regular expression is generated. In this case the regular expression 26 is <li>(*)<br>(*)</li>. In step 18 the semantics of the each slot or text field found between the tag sequences is hypothesized and labels are proposed for each field. In this case the wrapper 28 with labels is <li>(*)<br>(*)</li>, field1=title, field2=body.

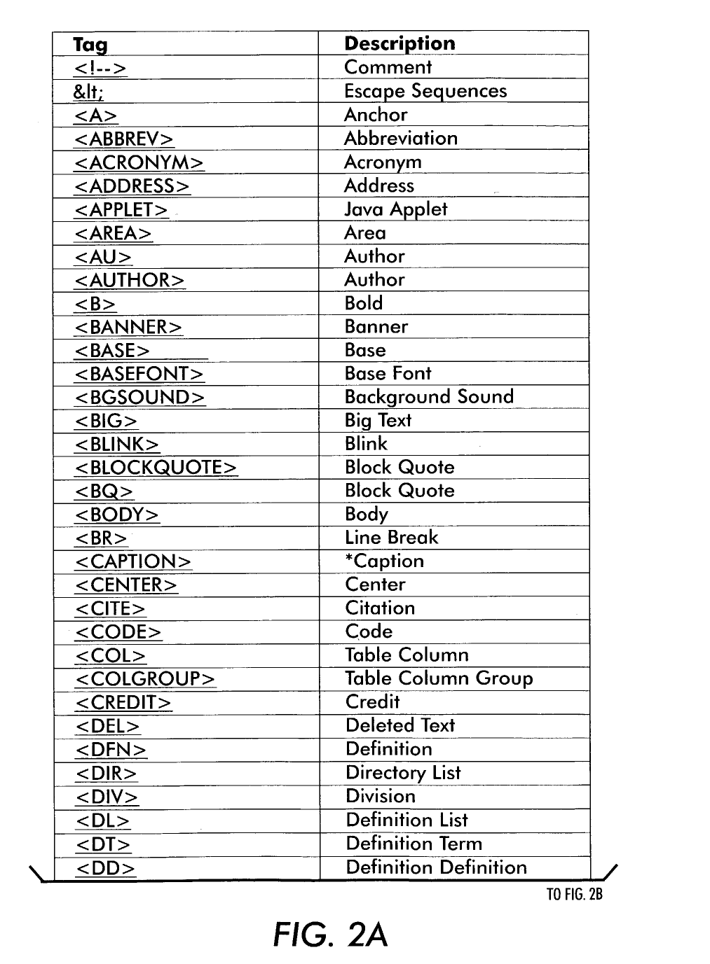

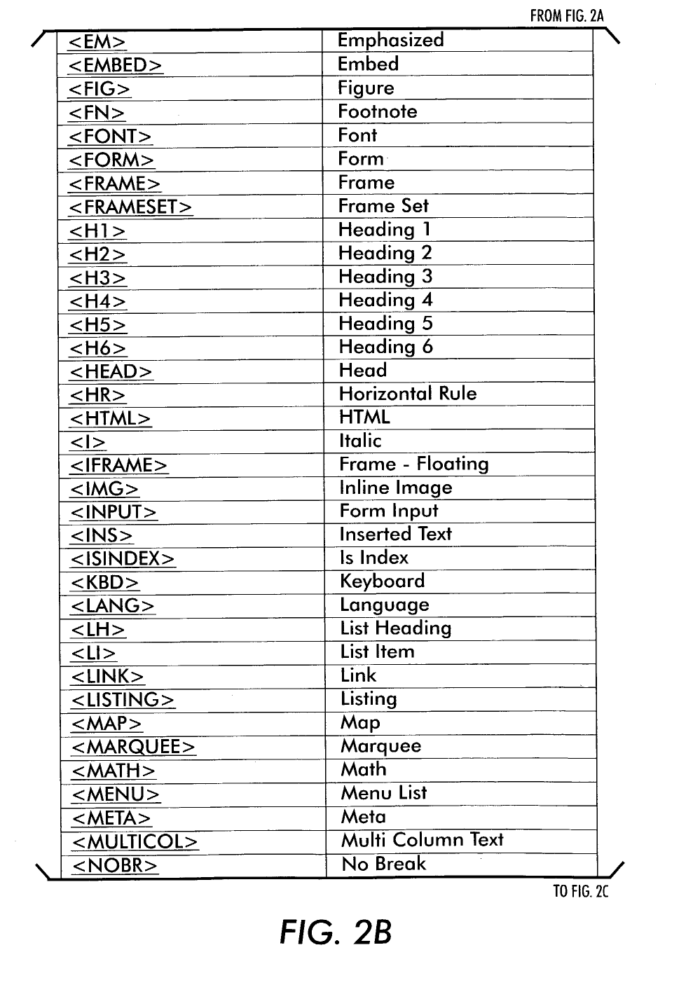

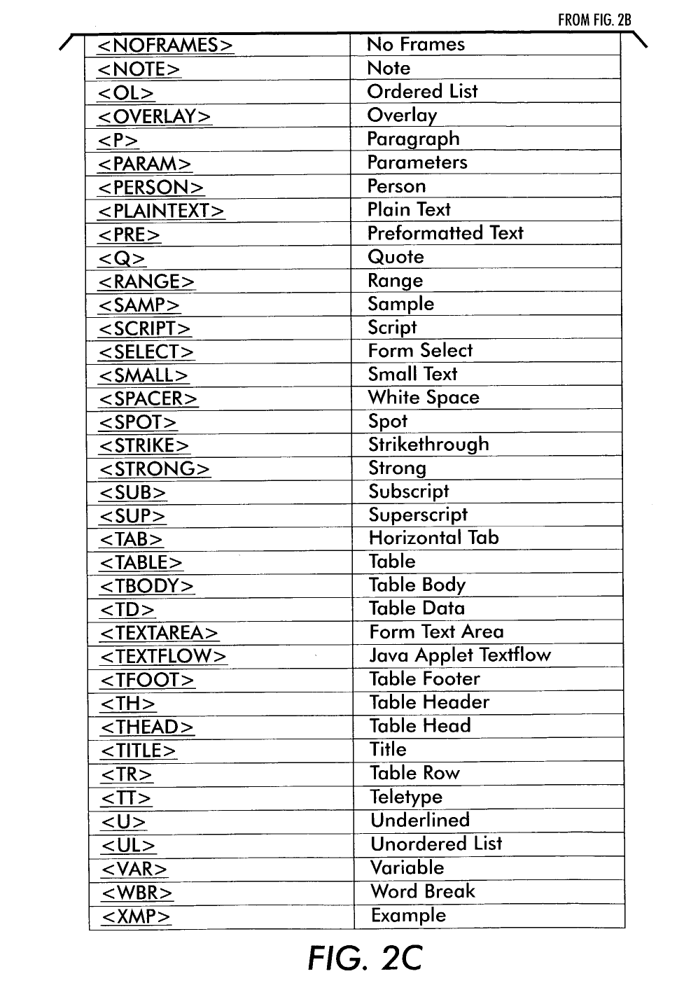

Various techniques can be used to hypothesize the labels. For example, a simple technique might propose generic labels, such as “list item 1, list item 2, etc.” Note that in some cases, the labels can be hypothesized from the definition of the particular HTML tag. FIG. 2 is a table of most HTML tags and their definitions. In this example, field2 was labeled “body” which corresponds to a sample value to denote the actual content. Alternatively, a semantics algorithm may be used to assign labels.

More complicated pages from Web-sites may result in multiple tag sequences of interest. In this case, a more complicated wrapper may be configured by constructing the longest and most repeated sequence, then the second longest and second most repeated sequence, and so on. Labels would be assigned for all text fields in each tag sequence.

The method of wrapper generation of the invention strives to fully automate the extraction process (wrapper creation process). Results contained within an HTML page are represented by a set of HTML tags. Those tags are repeated for every result (assuming there are multiple results). Repetitions of patterns or sequences in the list of tags are detected. The sequence that gets repeated most is likely to encode a result within the list. To account for minor variations within the list, such as an optional tag, the sequence of interest should be the most repeated and the longest one. That sequence is then used to generate a regular expression that will be used to extract the actual data from the HTML page.

A pseudo-algorithm for the finding the longest and most repeated sequence (steps 12-14) is shown below:

// Principle of the algorithm:
// ---------------------------
// 1 - we look for a repetitive sequence of tags
// 2 - we consume all sequential instances of that sequence
// 3 - we go back to step 1
for (int iTag = 0; iTag < list.size( ); iTag++) {

int startPos = iTag; // Marks begin of possible sequence
Sequence seq;
do {

seq = findSequence(list, startPos, iTag);
iTag++;

} while (iTag < list.size( ) && seq == null);

if (iTag == list.size( ) && seq == null) {

break;

}
seqs.addElement(seq);
seq.addCount( );
// Consume all instances of the current sequence
iTag += seq.getLength( );
while (iTag < list.size( )

&& iTag + seq.getLength( ) < list.size( )
&& matchSequence(list, seq.getStart( ), seq.
getLength( ), iTag)) {

seq.addCount( );
iTag += seq.getLength( ) + 1;

}

}

Example: A search of the IMAG, INRIA Rhone-Alpes, INRIA Rocquencout, INRIA Sophia-Antipolis, IRIAS, LORIA, RXRC databases using the query “aut=hubert” was made. The selected databases returned a single page containing 66 results matching the query of which 10 are listed below:

Complexite de suites definies par des billards rationnels

Hubert, P

p 257-270

Bulletin de la Societe Mathematique de France (Vol. 123, No. 2, 1995)

Sommaire

The breakdown value of the LI estimator in contingency tables

Hubert, M

p 419-426

Statistics and Probability Letters (Vol. 33, No. 4, 1997)

Sommaire

Proprietes combinatoires des suites definies par le billard dans les triangles pavants

Hubert, P

p 165-184

Theoretical Computer Science (Vol. 164, No. 1-2, 1996)

Sommaire

Viscous Perturbations of Isotropic Solutions of the Keyfitz-Kranzer System

Hubert, F

p 51-56

Applied Mathematics Letters (Vol. 10, No. 1, 1997)

Sommaire

Detecting degenerate behaviors in first order algebraic differential equations

Hubert, E

p 7-26

Theoretical Computer Science (Vol. 187, No. 1-2, 1997)

Sommaire

Des livres clefs: lire pour changer sa situation

Cukrowicz, Hubert

p 66-79

Bulletin des Bibliotheques de France (Vol. 40, No. 4, 1995)

Sommaire

Simulating Magnetooptic Imaging with the Tools of Fourier Optics

Wenzel, L; Hubert, A

p 4084-4086

IEEE Transactions on Magnetics (Vol. 32, No. 5-1, 1996)

Sommaire

Varietes hyperboliques et elliptiques fortement isospectrales

Pesce, Hubert

p 363-391

Journal of Functional Analysis (Vol. 134, No. 2, 1995)

Sommaire

Integrating Software Engineering into the Traditional Computer Science Curriculum

Johnson, Hubert A

p 39-45

SIGCSE Bulletin—Computer Science Education (Vol. 29, No. 2, 1997)

Sommaire

State of the art in robotic assembly

Rampersad, Hubert K

p 10-13

Industrial Robot (Vol. 22, No. 2, 1995)

Sommaire

The method of the invention was applied to this page of results. The longest and most frequent sequence of HTML tags was:

<hr> field1 <b> field2 <b> field3 <br> field4 <br> field5 <p> field6 <br> field7 <a href> field8>field9 </a>

The system generate a regular expression that would allow the wrapper to extract all the slots or “text fields”:

“(?im)(<hr>([\hat{ }<]*)<b>([\hat{ }<]*)</b>([\hat{ }<]*)<br>([\hat{ }<]*)<br>([\hat{ }<]*)<p>([\hat{ }<]*)<br>([\hat{ }<]*)<a (?:target=\″[\hat{ }\″]*\″\\s)*href=\″([\hat{ }″]*)\″[\hat{ }>]*>([\hat{ }<]*)</a>)”

The system then runs a test extraction using the generated regular expression to identify empty slots and to propose a first label for slots with content.

After labeling the “slots” or text fields, using hypothesized labels:

field2=title

field3=author

field4=pages

field6=journal

field8=URL

field9=TOC

The wrapper generated would generate the following results (raw output).

Hit1:

title: Complexite de suites definies par des billards rationnels (82, 141)

author: Hubert, P (149, 160)

pages: p 257-270 (164, 174)

journal: Bulletin de la Societe Mathematique de France (Vol. 123, No. 2, 1995) (177, 249)

url: /cgi-bin/sSs/html?00379484/123/2/index.html#257-270 (262, 313)

toc: Sommaire (315, 323)

Hit2:

title: The breakdown value of the L1 estimator in contingency tables (338, 401)

author: Hubert, M (409, 420)

pages: p 419-426 (424, 434)

journal: Statistics and Probability Letters (Vol. 33, No. 4, 1997) (437, 497)

url: /cgi-bin/sSs/html?01677152/33/4/index.html#419-426 (510, 560)

toc: Sommaire (562, 570)

Note that the above example only shows what the user actually sees in the web browser, the URL is hidden in the source. However, the system is able to extract the URL from the hidden source.

The labels generated in the above example were generated using the following semantic routine. For each field, the routine relies on several heuristics such as the location of the field, its nature (hyperlinked or not) as well as its format. Some of these criteria have been devised after studying a variety of web sites and finding commonalities in their result page. Title: usually represented by the first field and hyperlinked (i.e., as an associated URL), no longer than 22 words (average). Could also appear as the second when the first field represents the rank of the result (numerical value follow by a dot sign). The title is often emphasised using bold tags (<B>) or heading tags (<H1> . . . <H6>, <TH>). Abstract/body: usually represented by the field following the title and containing a minimum of 18 words (37 on average). When the abstract actually represents a snippet of the document, it might contain the search criteria (keywords). Date: identified by applying a regular conversion algorithm. If the conversion algorithm is able to transform the field into the standard format of the system, then a date field has been identified. For example, the system would convert “January 12, 1952” into “1952-01-12” or “Tuesday, April 12, 1952 AD 3:30:42 pm PST” into “1952-04-12”. Author: the scientific literature uses well-formed representations for authors combining first name, last name and initials of the authors separated by commas or semi-columns. The system is able to recognize the main formats in use such as: “Ramstock, K; Hubert, A; Berkov, D”, “Janusz Laski, Wojciech Szermer, and Piotr Luczycki” or “A. M. Grasso; B. Chidlovskii; and J. Willamowski”. Figures: the system tries to convert the field to a numerical representation. If the conversion succeeds then it has identified a figure. It also takes into account special signs such as the used for currencies or to denote special measures: percentage, kilobytes, megabytes, meters, inches, and temperature. Companies, people, such as a category or a specific collection; they might also identify a particular company or a specific name. Using an approach similar to the “ThingsFinder” based on a specific dictionary as well as syntactic rules, the system extracts proper names. When a known name is identified, the system labels the field with the category corresponding to the name: company, person, city, country, etc.

The slots or text fields can be labeled using any one of a variety of techniques. For example, the text fields could be labeled using a semantic routine such as the one described above. Ideally the algorithm would assign labels to every possible field. In practice, the algorithm is able to recognize only a handful on attributes like title, author, URL, page numbers and date based on a few simple heuristics like the position of the title. Alternatively, the text fields may be labelled using definitions of the particular HTML tags in the sequence. It should be noted that not all HTML tags define the meaning of the text enclosed within them. In general HTML tags are used to enforce some structure for presentation purposes. However, HTML tags can be used as a starting point to label slots, e.g.,. a “DT” tag transforms into “DefinitionTerm1”, for example.

The method has been used with typical search pages comprising regular result lists and provides good results. The method can also accommodate minor variations in the output format such as an additional element. If a sequence is fully contained within another longest sequence then additional tags can be marked as optional. The method should work particularly well on pages that are dynamically generated from database probes or other methods that are not directly accessible to the client.

The method yields generally good results cost-effectively and time-effectively, while falling short of the quality of manual techniques. The method strives to be fully automatic and removes any user input, but does not substitute for the programmatic approach or the learning-based approach of the wrapper designer in those instances where a more detailed approach is directed and time and resources are available. The method may not provide as good a result as the programmatic or the learning based approach for result lists that have a large number of optional elements or that present results of different types (e.g., DocuShare-type of results with documents, URLs, collection and events). large number of optional elements or that present results of different types (e.g., DocuShare-type of results with documents, URLs, collection and events).

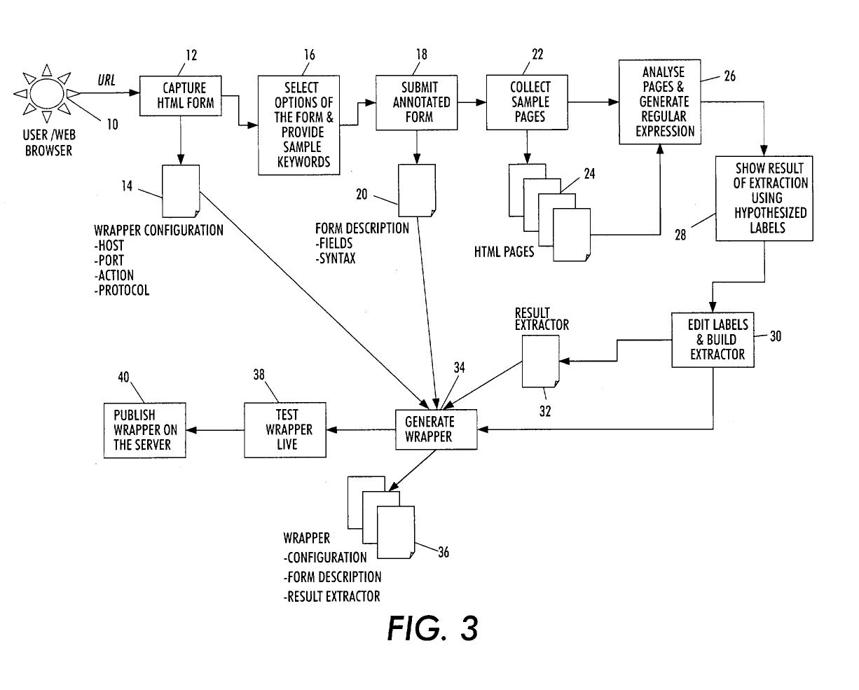

A method of automatically generating a wrapper according to another embodiment of the invention is shown in FIG. 3. In this embodiment, a more complicated wrapper is created. Referring to FIG. 3, the steps used in generating a wrapper for a web site are shown. In step 10 a user locates the web site in the user's web browser. In step 12, the HTML form of the displayed web page is captured. In step 14, the method identifies the configuration of the web page: host, port, action and protocol. In step 16 the method selects options from the HTML page and provides sample key words from the web page. In step 18, the web page is annotated and an annotated form submitted. In step 20 the form description is created, including fields and syntax. In step 22, the method collects sample HTML pages 24 from the web site. In step 26 the sample HTML pages are analyzed using the techniques described above and generates a regular expression. In step 28, the extraction result is used to hypothesize labels for the regular expression. In step 30, hypothesized labels are edited and the extractor is build. The resulting extractor including the regular expression and labels is obtained. In step 34 a wrapper 36 is generated using the results of steps 14 (wrapper configuration), 20 (form description) and 22 (result extractor). The wrapper is tested live in step 38 and if successful, the wrapper 36 is published on the server for use in a system, such as askOnce.

In step 12, the method may additionally process through several HTML forms for example, a login form, then a form to select catalog, then a search form. The result of the search query produces a result page. Note also that some result pages 24 may include links to additional result pages. The method may extract some information from the first result page (such as top level information), follow a link to a sub-level page where additional details of the result are available. The method may also perform some combination of multiple HTML forms and link following.

For example, the result page may be provided in accordance with the following: accessing the Web-site's login form; selecting a catalog from the Web-site; and performing a search query on the Web-site. If the result page includes at least one link to a second result page, the method detecting repeating sequences of HTML tags in the second page, wherein a sequence comprises at least two HTML tags enclosing at least one text field for containing variable data; and determining the longest and most frequently repeated sequence in both the result page and the second result page.

The invention has been described with reference to particular embodiments for convenience only. Modifications and alterations will occur to others upon reading and understanding this specification taken together with the drawings. The embodiments are but examples, and various alternatives, modifications, variations or improvements may be made by those skilled in the art from this teaching which are intended to be encompassed by the following claims.

What is claimed is:

1. A method of automatically generating a wrapper for extracting variable data from a Web-site, comprising:
providing a result page from the Web-site;
detecting repeating sequences of HTML tags in the page, wherein a sequence comprises at least two HTML tags enclosing at least one text field for containing variable data;
determining the longest and most frequently repeated sequence;
generating an expression for extracting variable data using the first determined sequence; and
assigning a label to the at least one text field within the first determined sequence.

2. The method of claim 1, further comprising:
determining the second longest and second most frequently repeated sequence;
generating an expression for extracting variable data using the first and second determined sequences; and
assigning a label to the at least one text field within the second sequence.

3. The method of claim 1, wherein the step of assigning a label to the at least one text field comprises evaluating the semantics of the at least one text field and assigning a label based on the evaluated semantics.

4. The method of claim 3, wherein the assigned label comprises at least one of title, author, URL and date.

5. The method of claim 1, wherein the step of assigning a label to the at least one text field comprises evaluating the HTML tags surrounding the at least one text field.

6. A method of automatic generating a wrapper for extracting variable data from a Web-site, comprising:
providing a single page of results from the Web-site;
extracting sequences of HTML tags from the provided page;
identifying repeating patterns of tag sequences;
selecting the longest and most repeated tag sequence;
generating an expression for extracting variable data from within the selected sequence;
evaluating the semantics for each slot formed by a pair of HTML tags; and
labeling the slots.

7. The method of claim 6, wherein the longest and most repeated tag sequence comprises a first tag, a text field and a second tag.

8. The method of claim 6, wherein the longest and most repeated tag sequence comprises a first tag, a first text field, a second tag, a second text field and a third tag.

9. The method of claim 1, further comprising:
determining the Web-site's configuration.

10. The method of claim 9, wherein the Web site's configuration includes host, port, action, protocol, and activation of cookies.

11. The method of claim 1, further comprising:
determining the Web-site's form.

12. The method of claim 11, wherein the Web-side form includes fields and syntax.

13. The method of claim 1, wherein the result page is provided in accordance with the following:
accessing the Web-site's login form;
selecting a catalog from the Web-site; and
performing a search query on the Web-site.

14. The method of claim 1, wherein the result page includes at least one link to a second result page; and
detecting repeating sequences of HTML tags in the second page, wherein a sequence comprises at least two HTML tags enclosing at least one text field for containing variable data; and
determining the longest and most frequently repeated sequence in both the result page and the second result page.

15. The method of claim 13, wherein the result page includes at least one link to a second result page; and
detecting repeating sequences of HTML tags in the second page, wherein a sequence comprises at least two HTML tags enclosing at least one text field for containing variable data; and
determining the longest and most frequently repeated sequence in both the result page and the second result page.
